(19) United States
(12) Patent Application Publication
(10) Pub. No.: US 2015/0368859 A1
(43) Pub. Date: Dec. 24, 2015

(54) STEEL CORD AND ELASTIC CRAWLER USING SAME

(71) Applicants: SUMITOMO RUBBER INDUSTRIES, LTD., Hyogo (JP); TOKUSEN KOGYO CO., LTD., Ono-shi, Hyogo (JP)

(72) Inventors: Akihiro NISHIMURA, Kobe-shi (JP); Satoshi YOSHIDA, Ono-shi (JP)

(73) Assignees: TOKUSEN KOGYO CO., LTD., Ono-shi, Hyogo (JP); SUMITOMO RUBBER INDUSTRIES, LTD., Kobe-shi, Hyogo (JP)

(21) Appl. No.: 14/764,672

(22) PCT Filed: Feb. 3, 2014
(86) PCT No.: PCT/JP2014/052442

§ 371 Date: Jul. 30, 2015

(30) Foreign Application Priority Data
Feb. 21, 2013 (JP) 2013-032366

(51) Int. Cl. D07B 1/06; B62D 55/24

(52) U.S. Cl. CPC D07B 1/0693; B62D 55/244

(57) ABSTRACT

A steel cord is configured so that, when the steel cord is used as a tensile cord for an elastic crawler, a center-core dislocation and the early breakage of the wires of a core are prevented. A steel cord comprises: a core which comprises a single core strand, and a sheath which is formed by twisting together six sheath strands arranged around the core. The core strand has a layer-twisted structure comprising: a center-core portion which is formed by twisting three core wires together; and an external layer portion which is formed by twisting together eight to nine core wires arranged around the center-core portion. The sheath strands each have either a bundle twisted structure which is formed by twisting twelve to nineteen sheath wires or a multi-layer twisted structure which is formed by twisting twelve to nineteen sheath wires in layers. The diameter (dc) of the core wires is greater than the diameter (ds) of the sheath wi res. The average gap (Gc) between the core wi res of the external layer portion is 0.015 mm or greater, and the average gap (Gs) between the sheath strands is 0.1 mm or greater.

### TECHNICAL FIELD

The present invention relates to a steel cord, which is suitable for a tensile strength cord of the elastic crawler and is capable of preventing wire center-core dislocation in a core and early breakage of the wire in the core, and an elastic crawler using the same

### BACKGROUND OF THE ART

A crawler type traveling device adopted in the traveling section of an agricultural machine, a constructing machine and the like comprises an endless band-formed elastic crawler wound revolvably by a driving wheel (sprocket), an idler, tracker roller and the like. The elastic crawler comprises an endless band-formed crawler main body made of rubber elastic material and a tensile member for reinforcement embedded in it. The tensile member comprises a plurality of tensile strength cords extending continuously in a crawler circumferential direction. In particular, an elongated band body is once wound in the crawler circumferential direction and its circumferential both ends are superimposed and connected so as to form the endless band-formed tensile member. And the band body is formed by coating an array body of the tensile strength cord arranged in the longitudinal direction with topping rubber.

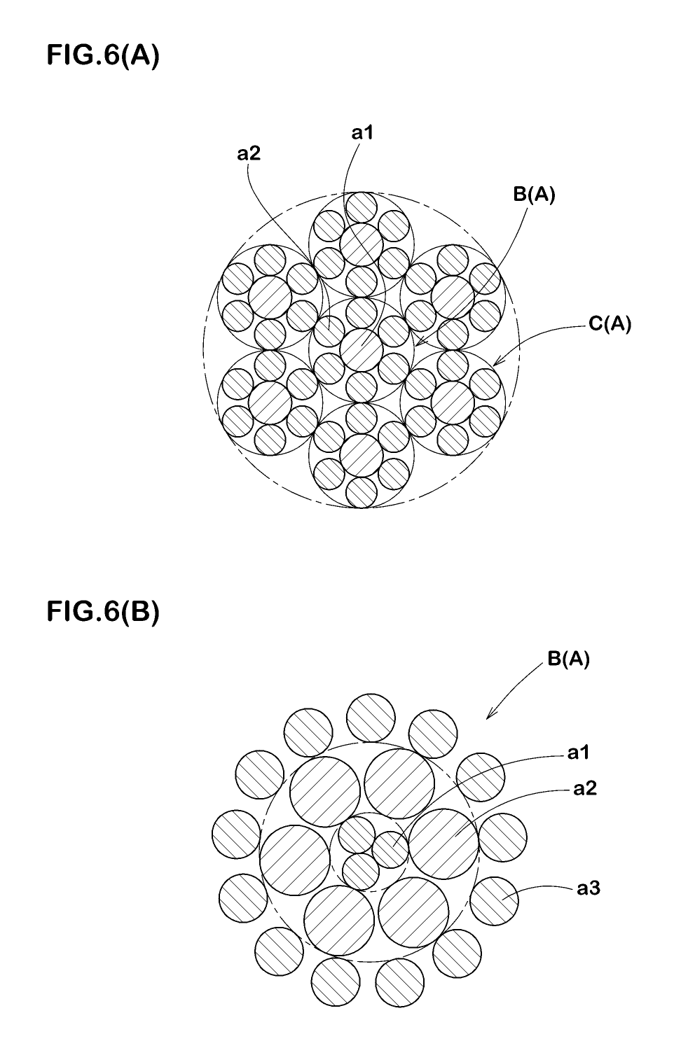

On the other hand, as shown in FIG. 6(A), a steel cord having a structure of 7×(1+6), which comprises seven strands A each having the same 1+6 structure, is proposed as the tensile strength cord (Patent Document 1, for example). That is to say, the tensile strength cord comprises a core B made of a single strand A and a sheath C formed by twisting six strands A disposed around the core B.

However, when the steel cord has the above-mentioned structure, in the strand A forming the core B, a wire (a1) forming a center-core portion of the core is single and is not twisted with other wire (a2) disposed around it. There is therefore a problem that load and flexion exerting repeatedly while the vehicle is moving make the wire (a1) forming the center-core portion of the core to protrude from a cord end in the axial direction by little and little and eventually to break through a crawler rubber main body so as to protrude from the outer periphery of a elastic crawler.

Moreover, when the cord formed by twisting a plurality of strands A, the wire of the strand A forming the core B tends to break earlier. Causatively, when tensile force exerts on the cord, there is a possibility that the strand A, which forms a sheath C, constricts the strand A, which forms the core B. According to this, not only tension load but also tightening load are exerted on the wire of the core B and contacts pressure between the wires is increased. And it is estimated that these causes early breakage. Specifically, as shown in FIG. 6A, when the wires forming the core B have different thicknesses (diameters), it causes a problem that the early breakage arises more significantly in a thinner wire and deteriorates cord strength.

Also, as shown in FIG. 6(B), the applicant of the present invention proposes to employ the 3+6+12 layer-twisted structure for the strand A of the core B. this structure comprises, a central portion formed by twisting three wires (a1), a first external layer portion formed by twisting six wires (a2) disposed around the central portion, and a second external layer portion formed by twisting twelve wires (a3) disposed around the first external layer (see Patent Document 2). In this structure, since the central portion of the core B is formed by twisting the three wires (a1), it produces an effect on center-core dislocation of the core B. There are however large differences between the thicknesses (diameters) of the wires (a1), (a2), (a3) of the core B; therefore, it produces no effect on the early breakage of the wire in the core B.

### RELATED ART DOCUMENTS

### Patent Documents

Patent Document 1: Japanese Patent Publication No. 2001-20188

Patent Document 2: Japanese Patent No. 4021224

### SUMMARY OF THE INVENTION

### Problems that the Invention is to Solve

The present invention aims to provide a steel cord, which enable to be used as a tensile strength cord of the elastic crawler and to reduce center-core dislocation of a wire and early breakage of the wire in a core, and an elastic crawler using the same.

### Means of Solving the Problems

To solve the above problem, the invention according to claim 1, a steel cord comprises a core formed of a single core strand, and a sheath formed by twisting together six sheath strands arranged around the core. The core strand has a layer-twisted structure comprising a center-core portion formed by twisting together three core wi res and an external layer portion formed by twisting together the eight to nine core wires arranged around the center-core portion. The sheath strand each has either a bundle-twisted structure formed by bundling and twisting twelve to nineteen sheath wires, or a multi-layer twisted structure formed by twisting twelve to nineteen sheath wires in layers. A diameter (dc) of each of the core wires is greater than a diameter (ds) of each of the sheath wires. And an average gap (Gc) between the core wires of the external layer portion is not less than 0.015 mm, and an average gap (Gs) between the sheath strands is not less than 0.1 mm.

In claim 2, a real cord cross-sectional area S1, which is a sum total of a sum of wire cross-sectional area of the core wire and a sum of a wire cross-sectional area of the sheath wire, is more than 48% and less than 51% of a apparent cord cross-sectional area S0, which is an area of the smallest diameter circumscribed circle among circumscribed circles surrounding the steel cord.

In claim 3, a diameter Dc of the core strand of more than 35% of a diameter D0 of the steel cord.

In claim 4, an elastic crawler including an endless band-formed crawler main body made of rubber elastic material, and a tensile member embedded in the crawler main body. The tensile member comprises a plurality of tensile strength cords continuously extending in the crawler circumferential direction. And for the tensile strength cord, the steel cord as set forth in any one of claims 1 to 3 is employed.

### Effect of the Invention

In the steel cord according to the present invention, a core strand forming a core has a 3+N layer-twisted structure (N=8 to 9) comprising a center-core portion formed by twisting three core wires, and an external layer portion formed by twisting eight to nine core wires. A sheath strand forming a sheath has a 1×M bundle-twisted structure (M=12 to 19) formed by twisting 12 to 19 sheath wires in a bundle, and alternatively, a multi-layer twisted structure formed by twisting 12 to 19 sheath wires in layers. For the multi-layer twisted structure, an m+n structure (m+n=12 to 19) and an m+n+s structure (m+n+s=12 to 19) are preferably employed.

In this manner, in the core, its center-core portion is formed of a twisted body of three core wires, thereby inhibiting the center-core dislocation of the core.

In the present invention, the core strand is formed of the core wires each having the same wire diameter. The sheath strand can be formed of the sheath wires each having the same wire diameter and also be formed of the sheath wires having different wire diameters. In addition, the diameter (dc) of the core wire is set to be larger than the diameter (ds) of the sheath wire, thereby inhibiting the early breakage of the wire in the core strand.

The reason for above is as follows: when tensile force is exerted on the cord, the core strand is constricted by the sheath strands; therefore, tightening load unnecessarily acts on the wire of the core strand as compared to the wire of the sheath strand, also contact pressure between the wires increases. However, in the present invention, the core wire is set to be thicker than the sheath wire thereby the strength of the core being relatively high compared with that of the sheath wire. Moreover, the core strand is formed of the same core wires. That is to say, since the strength of each wire forming the core strand is even, a weak point of the strength can be cleared out. As a result, it is possible to effectively suppress the early breakage.

And in the present invention, an average gap Gc between the core wires in the external layer portion is set to not less than 0.015 mm, and the average gap Gs between the sheath strands is set to not less than 0.1 mm. Accordingly, those would be enough to ensure rubber permeability around the core strand and into the core strand. In consequence, owing to the adhesion with penetrating rubber, the center-core dislocation of the center-core portion can be inhibited more. And, the penetrating rubber lightens up the tightening load to the core wire and the contact pressure between the core wires; thereby the early breakage in the core wire can be inhibited all the more.

In addition, when the sheath strand is set to have a 1×M bundle-twisted structure, its cross-section is compact, and the average gap Gs would be enough to be ensured while having the same steel quantity. Also, since the contact area between the sheath wi res is large owing to the employment of the bundle-twisted structure, it helps to inhibit fretting wear. And when the sheath strand has a multi-layer twisted structure, the sheath strand can improve the stability of twisting form.

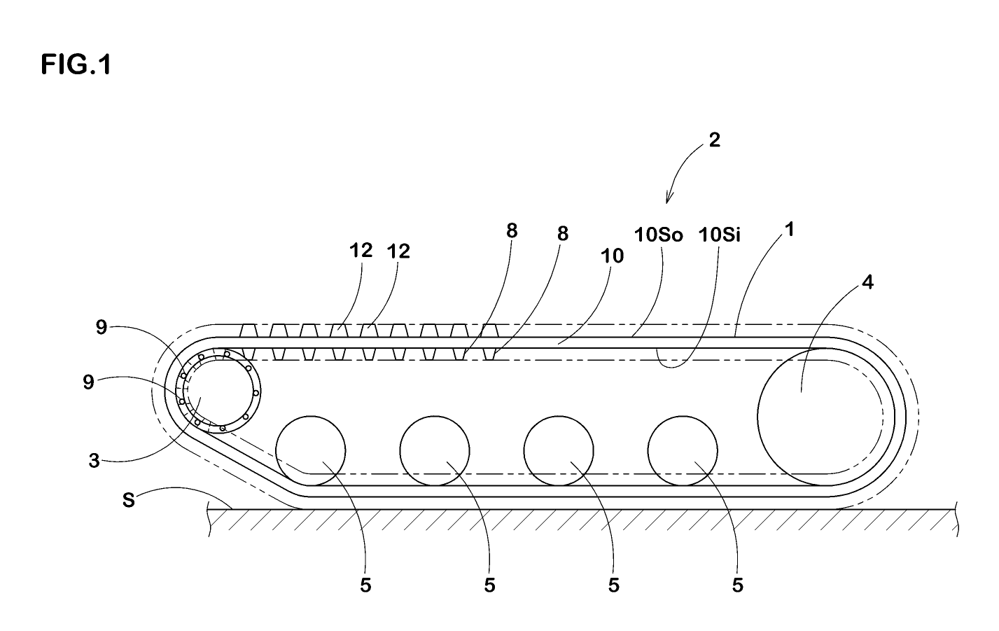

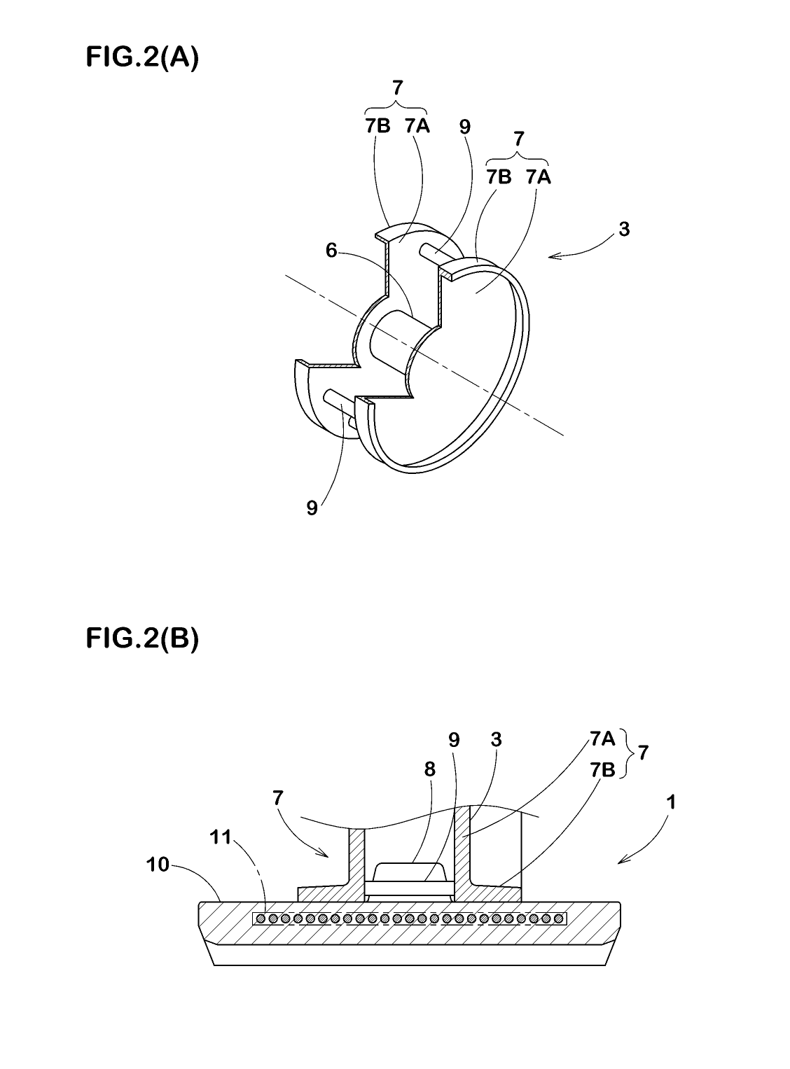

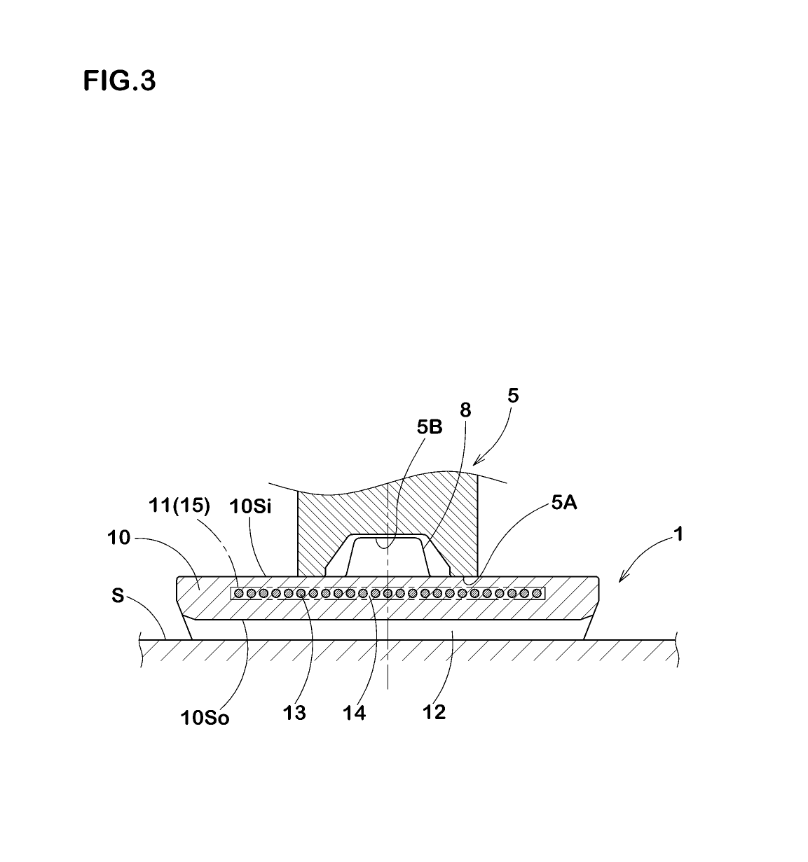

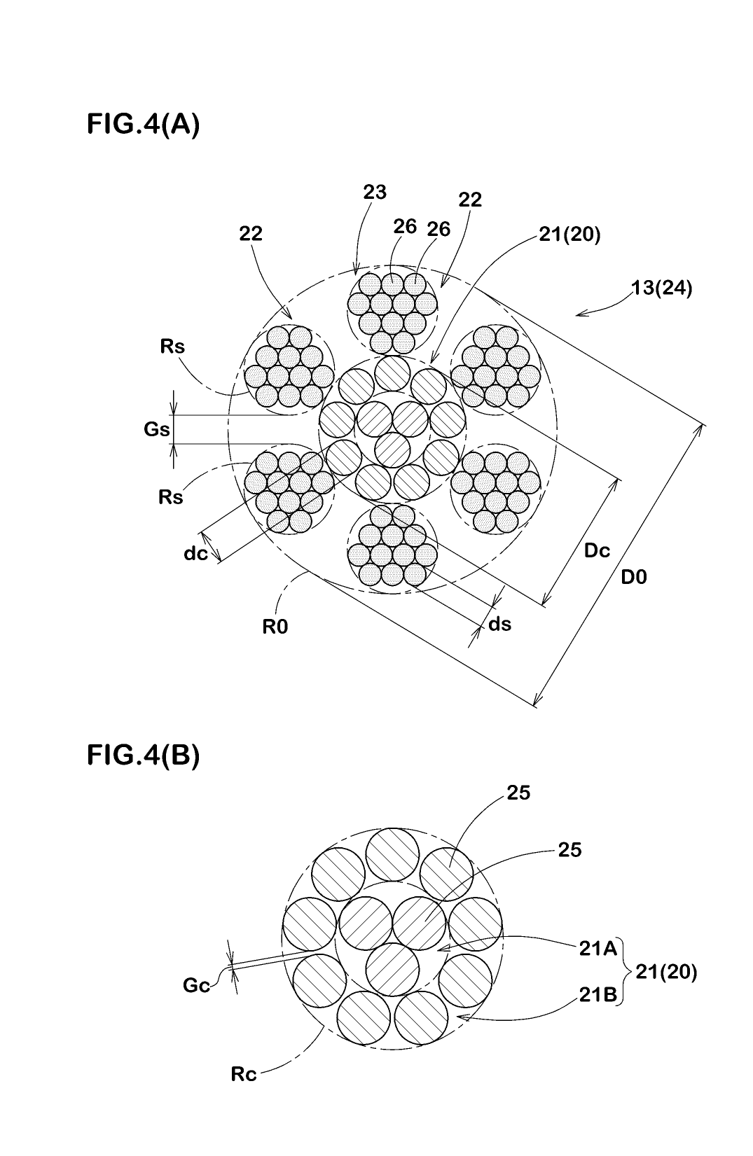

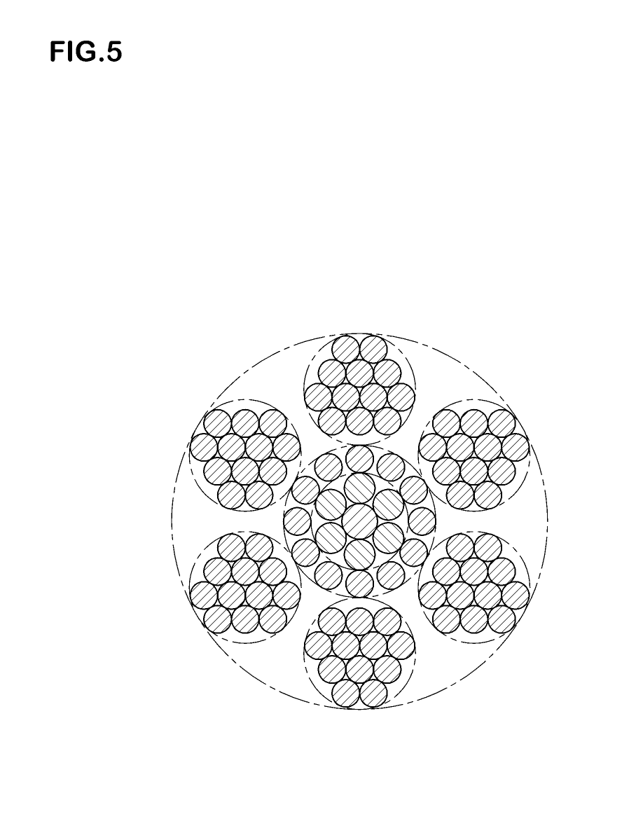

### BRIEF DESCRIPTION OF THE DRAWINGS

[FIG. 1] is a side view showing a part of a vehicle mounted with the elastic crawler according to the present invention.

[FIG. 2] (A) is a perspective view conceptually showing a driving wheel; and (B) is a partial cross-sectional view showing the elastic crawler with a driving wheel.

[FIG. 3] is a partial cross-sectional view showing the elastic crawler with the tracker roller.

[FIG. 4] (A) is a cross-sectional view of a tensile strength cord; and (B) is a cross-sectional view of a core strand.

[FIG. 5] is a cross-sectional view of the tensile strength cord of the Comparative Example 1 in Table 1.

[FIGS. 6] (A) and (B) are cross-sectional views of a conventional tensile strength cord.

### Modes for Carring out the Invention

An embodiment of the present invention will be described in detail.

FIG. 1 is a side view showing a part of a vehicle 2 fitted with an elastic crawler 1 according to the present invention. The vehicle 2 comprises a driving wheel 3, an idler 4, and a plurality of tracker rollers 5 on both sides of the vehicle body, respectively.

The driving wheel 3 is located on one side in the advancing direction of vehicle (front-side end, in the present embodiment). To improve running performance for climbing over protrusion from a road surface S, the driving wheel 3 is located apart above from the road surface S. The driving wheel 3 of the present embodiment comprises, as conceptually shown in FIG. 2, a pair of wheel portions 7 attached to the both ends of a central shaft 6. Each of the wheel portions 7 comprises discoidal side plates 7A concentrically fixed to the central shaft 6, and a cylindrical flange portion 7B bent outwardly in the axial direction from the outer perimeter edge of the side plates 7A. A plurality of engaging pins 9 are disposed between the side plates 7A, 7A at regular intervals in the circumferential direction. The engaging pins 9 interlock with projection portions 8 disposed on the elastic crawler 1 to transmit the power to the elastic crawler 1

The idler 4 is provided on the other end in the advancing direction of vehicle (rear-side end, in the present embodiment), and rotates dependently on the circularly movement of the elastic crawler 1.

The tracker roller 5 guides the elastic crawler 1 so as to go around between the driving wheel 3 and the idler 4 while pressing the elastic crawler 1 on the road surface S. Therefore, the vehicle 2 can run. This tracker roller 5 comprises, in the present embodiment, as shown in FIG. 3, a large-diameter pressing surface portion 5A positioned on the both end sides in the axial direction and pressing the elastic crawler 1 on the road surface S, and a small-diameter concave portion 5B positioned on a middle side in the axial direction to avoid impingement with the projection portion 8 of the elastic crawler 1 while running.

Next, the elastic crawler 1 includes, as shown in FIGS. 1 and 3, an endless band-formed crawler main body 10 made of rubber elastic material, and a tensile member 11 embedded in the crawler main body 10.

The crawler main body 10 is provided on an inner periphery 10 Si with a plurality of projection portions 8. The projection portions 8 interlock with the engaging pins 9 located in the driving wheel 3 and transmit the power from the driving wheel 3. The projection portions 8 and the engaging pins 9 are therefore arranged in the crawler circumferential direction at regular pitches. In the present embodiment, each of the projection portions 8 has a square-pyramid-trapezoidal shape, but is not limited to. For example, the driving wheel 3 can be liberally provided with groove portions such as in a sprocket or in a gear and the projection portions 8 of the crawler main body 10 is formed as tooth so as to interlocking with the groove portion.

Each of the projection portions 8 is formed of the same rubber as the crawler main body 10 in the present embodiment. But it can be formed of high elastic rubber having larger elastic modulus than the crawler main body 10, for example. Another example, short fiber compounded rubber containing short fibers in the rubber can be employed for the projection portion 8 to reinforce. Note that the sign 12 in Drawings indicates a lag rib protruding from the outer periphery 10So of the crawler main body 10 and extending in the crawler width direction to improve the grip performance with the road surface S.

Next, the tensile member 11 includes a plurality of tensile strength cords 13 extending in the crawler circumferential direction. The tensile member 11 of the present embodiment is formed by using an elongated band body 15. The elongated band body 15 comprises a cord array body where the tensile strength cords 13 extending continuously in the crawler circumferential direction is arranged parallel in the crawler width direction, and a topping rubber 14 coating this cord array body. Specifically, the band body 15 is wound once in the crawler circumferential direction, and the circumferential ends are connected by overlapping one another so as to form the tensile member 11 in endless band-formed.

Also, for the tensile strength cord 13, as shown in FIG. 4(A), employed is a steel cord 24. The steel cord 24 comprises a core 21 made of a single core strand 20 and a sheath 23 formed by twisting together six sheath strands 22 disposed around this core 21.

The core strand 20 has, as shown in FIG. 4(B), a 3+N layer-twisted structure (N=8 to 9) comprising center-core portion 21A formed by twisting three core wires 25, and an external layer portion 21B formed by twisting eight to nine core wires 25 disposed around the center-core portion 21A. In FIGS. 4(A) and (B), expedientially the core wire 25 forming the center-core portion 21A is different from the core wire 25 of the external layer portion 21B in the cross-sectional designs, but they are formed of substantially the same wires.

In the core strand 20, at least one of the twisting direction and twisting pitch of the center-core portion 21A is different from the twisting direction and twisting pitch of the external layer portion 21B. In this case, it is preferable in increasing the contact area between the core wires 25 so as to reduce the fretting wear between the core wires 25 that the center-core portion 21A and the external layer portion 21B have the same twisting direction. However, it may possible to differ both of the twisting direction and twisting pitch.

Each of the sheath strands 22 has a 1×M bundle-twisted structure (M=12 to 19) formed by twisting twelve to nineteen sheath wires 26 in a bundle, and alternatively, a multi-layer twisted structure formed by twisting twelve to nineteen sheath wires 26 in layers. For the multi-layer twisted structure, an m+n structure (m+n=12 to 19) and an m+n+s structure (m+n+s=12 to 19) are preferably employed.

The diameter (dc) of the core wire 25 is larger than the diameter (ds) of the sheath wire. In this manner, the center-core portion 21A of the core 21 are formed of a twisted body of three core wire 25, thereby increasing the binding force between core wires 25 and improving the binding force from the external layer portion 21B of the center-core portion 21A. Therefore, the dislocation of the center-core portion 21A itself and the dislocation of the core wire 25 in the center-core portion 21A can be inhibited.

Also, the core strand 20 is formed of the core wires 25 each having the same wire diameter. The sheath strand 22 may be formed of the sheath wires 26 each having the same wire diameter or the sheath wire 26 each having a different wire diameter. The diameter (dc) of the core wire 25 is set to be larger than the diameter (ds) of the sheath wire 26, thereby inhibiting the early breakage of the core wire 25 in the core strand 20.

That is to say, the core wire 25 is thicker than the sheath wire 26 so as to relatively improve the strength of the core wire 25 compared to the strength of the sheath wire 26. Moreover, since the core strand 20 is formed of the same core wire 25, the weak point in the strength of the wire can be cleared out. In consequence, the early breakage can be effectively inhibited. A ratio (dc/ds) between the diameters (dc), (ds) is preferably not less than 1.5. when it is below 1.5, the inhibitive effect of the early breakage is disadvantaged. Note that if the sheath wires 26 of the sheath strand 22 are not the same but different in the wire diameter, the diameter (ds) indicates a wire diameter of outermost filament of the sheath strand 22.

Moreover, in the steel cord 24, the average gap Gc between the core wires 25 in the external layer portion 21B is set to not less than 0.015 mm, and the average gap Gs between the sheath strands 22 is set to not less than 0.1 mm. Therefore, the rubber permeability around the core strand 20 and into the core strand 20 can be sufficiently secured. And as a result, an adhesion between the entering rubber and the center-core portion 21A can inhibit more the center-core dislocation of the center-core portion 21A. Also the entering rubber lightens up the tightening load to the core wires 25 and the contact pressure between the core wires 25, thereby inhibiting more the early breakage of the core wires 25.

Meanwhile, when the sheath strand 22 has the bundle-twisted structure, a cross-section is compactable and can sufficiently secure the average gap Gs while keeping the same quantity of steel. Furthermore, owing to the bundle-twisted structure, the contact area of the sheath wires 26 is large, thereby having an advantage in the fretting wear. Also, when the sheath strand 22 has the multi-layer twisted structure, the sheath strand 22 can improve the stability of twisting form. Meanwhile, the average gap Gc means a value obtained by dividing the sum ΣGc of the gaps Gc between the core wires 25 in the external layer portion 21B by the number of the gaps. Also, the average gap Gs means a value obtained by dividing the sum ΣGs of the gaps Gs between the sheath strands 22 by the number of the gaps. Furthermore, the gap Gs between the sheath strands 22 means a gap between the circumscribed circles Rs which is defined as the smallest-diameter circumscribed circle among circumscribed circles around the sheath strand 22.

The upper limit of the average gap Gc is limited by the average gap Gc in the case that the core strand 20 has a 3+8 layer-twisted structure. The upper limit of the average gap Gs is limited by the average gap Gs in the case that the sheath strand 22 has a 1×12 bundle-twisted structure.

Next, in the steel cord 24, a real cord cross-sectional area S1 is preferably larger than 48% and smaller than 51% of an apparent cord cross-sectional area S0. The real cord cross-sectional area S1 is indicated by a sum total (ΣSc+ΣSs) of the sum ΣSc of a wire cross-sectional area Sc of each of the core wires 25 and the sum ΣSs of ta wire cross-sectional area Ss of each of the sheath wires 26. The apparent cord cross-sectional area S0 is indicated by an area of the smallest-diameter circumscribed circle R0 among the circumscribed circles around the steel cord 24.

Since the real cord cross-sectional area S1 is smaller than 51% of the apparent cord cross-sectional area S0, a ratio of filled rubber in the cord increases. Accordingly, the filled rubber can reduce the tightening load to the core wires 25 and the contact pressure between the core wires 25, thereby having advantages in an inhibition of the early breakage and in an inhibition of the center-core dislocation of the core 21. Meanwhile, when the real cord cross-sectional area S1 is less than 48% of the apparent cord cross-sectional area S0, the steel rate decreases, thereby causing the decrease of the cord strength itself.

The diameter Dc of the core strand 20 is preferably larger than 35% of the diameter D0 of the steel cord 24. The diameter Dc of the core strand 20 is indicated by the smallest-diameter among the diameters circumscribed circles around the core strand 20. The diameter D0 of the steel cord 24 is a diameter of the circumscribed circle R0.

When the ratio of the diameter Dc of the core strand 20 of the diameter Dc to the diameter D0 of the steel cord 24 is large, inescapably the rate of the diameter Ds of the sheath strand 22 is small . Therefore, the average gap Gs between the sheath strands 22 increases. Thus, the diameter Dc is set to larger than 35% of the diameter D0, thereby enabling to increase the average gap Gs and improving the rubber permeability inside the cord. In the result, it has advantages in the inhibition of the early breakage and center-core dislocation. And the diameter Dc is more preferably not less than 40% of the diameter D0. Moreover, its upper limit is limited by the ratio Dc/D0 where the sheath strand 22 has the 1×12 bundle-twisted structure.

Although especially preferred embodiment of the present invention has been described in detail, the invention is not limited to the illustrated embodiment, and various modifications can be made.

### Embodiment

To confirm the effect of the present invention, test steel cords having the specifications shown in Table 1 were made, and hygrothermal aging performance of each of the steel cords was tested. Test elastic crawlers shown in FIGS. 2 and 3 where the test steel cords were employed as tensile strength cords of a tensile member, and durability and center-core dislocation performance of the tensile strength cord in each of the elastic crawlers were tested in an actual vehicle. The specification except the items shown in Table 1 was substantially the same. The tensile member was 3.8 mm in thickness, and the cord number of the tensile strength cord was 12 pieces/50 mm. A cross-sectional of the steel cord of the Comparative Example 1 is shown in FIG. 5.

(1) Hygrothermal Aging Performance:

A sheet body obtained by sandwiching the steel cords between topping rubbers and having a thickness of 3.8 mm was vulcanized at 150 deg. C. for 30 minutes. Then, the vulcanized sheet body was left for 150 hours under a hygrothermal aging condition (temperature of 80 deg. C., relative humidity of 98%), and taking the steel cords from the sheet body. In observing the steel cords within the length of 20 mm under a microscope, a search was done regarding presence or absence of occurrence of corrosion. The result was rated on a scale of zero to five, absence of the occurrence of corrosion was zero. The higher score means more corrosion and less rubber permeability.

(2) Center-Core Dislocation Performance:

The elastic crawler was mounted on a small shovel with a weight of 3500 kg and driven 400 km on a circuit course at a speed of 3.0 km/h. After driving, the elastic crawler was dismantled so as to visually confirm presence and absence of protruding (center-core dislocation) of a core wire from an end portion of the steel cord.

(3) Durability:

The elastic crawler was mounted on the small shovel with a weight of 3500 kg and driven 500 km on the circuit course at a speed of 3.0 km/h. After driving, the elastic crawler was dismantled so as to confirm occurrence spot of subsidiary fracture of a wire in the steel cord. Evaluation is displayed using indiceswith the Comparative Example 1 being 100. The larger the numeric value was, the less occurrence spot of subsidiary fracture was; and excellent at durability.

TABLE 1

| | Ex. 1 | Ex. 2 | Ex. 3 | Ex. 4 |
|---|---|---|---|---|
| Core strand | 3 + 9 | 3 + 8 | 3 + 8 | 3 + 9 |
| Diameter (dc) of core wire [mm] | 0.23/0.23 | 0.28/0.28 | 0.23/0.23 | 0.33/0.33 |
| Average gap Gc [mm] | 0.018 | 0.022 | 0.048 | 0.026 |
| Sheath strand | 1 × 12 | 1 + 6 + 12 | 1 + 6 + 11 | 3 + 9 |
| Diameter (ds) of sheath wire [mm] | 0.175/0.175 | 0.22/0.19/0.175 | 0.15/0.15/0.15 | 0.28/0.28 |
| Average gap Gs [mm] | 0.123 | 0.107 | 0.103 | 0.104 |
| Area ratio S1/S0 | 50.4 | 50.5 | 49.9 | 50.8 |
| Diameter ratio Dc/Do | 40.2 | 38.0 | 38.9 | 37.1 |
| Wire diameter ratio dc/ds | 1.31 | 1.60 | 1.53 | 1.18 |
| Center-core dislocation | Absent | Absent | Absent | Absent |
| Hygrothermal aging performance | 0 | 0S | 0 | 0.5 |
| Durability | 120 | 115 | 108 | 110 |

| | Com. Ex. 1 | Com. Ex. 2 | Com. Ex. 3 | Com. Ex. 4 | Com. Ex. 5 |
|---|---|---|---|---|---|
| Core strand | 1 + 6 + 12 | 1 + 6 + 12 | 3 + 8 | 3 + 9 | 3 + 8 |
| Diameter (dc) of core wire [mm] | 0.22/0.19/0.175 | 0.255/0.23/0.22 | 0.19/0.19 | 0.22/0.22 | 0.35/0.35 |
| Average gap Gc [mm] | 0.026 | 0.022 | 0.039 | 0.017 | 0.073 |
| Sheath strand | 1 × 12 | 1 + 6 + 12 | 1 × 19 | 1 × 19 | 1 + 6 + 12 |
| Diameter (ds) of sheath wire [mm] | 0.175/0.175 | 0.22/0.19/0.175 | 0.15/0.15/0.15 | 0.18/0.18/0.18 | 0.28/0.28/0.28 |
| Average gap Gs [mm] | 0.120 | 0.103 | 0.020 | 0.007 | 0.027 |
| Area ratio S1/S0 | 50.5 | 51.0 | 56.5 | 58.0 | 56.8 |
| Diameter ratio Dc/Do | 40.1 | 37.8 | 34.5 | 33.7 | 34.2 |
| Wire diameter ratio dc/ds | 1.00 | 1.31 | 1.27 | 1.22 | 1.25 |
| Center-core dislocation | Present | Present | Present | Absent | Absent |
| Hygrothermal aging performance | 3 | 5 | 0 | 3 | 1 |
| Durability | 100 | 85 | 75 | 90 | 70 |

As shown in FIG. 1, it was confirmed the cords of Examples were excellent at the center-core dislocation resistance and the subsidiary fracture inhibitive effect of the wire.

### EXPLANATION OF THE REFERENCE

1 Elastic crawler

10 Crawler main body

11 Tensile member

13 Tensile strength cord

20 Core strand

21 Core

21A Center-core portion

21B External layer portion

22 Sheath strand

23 Sheath

24 Steel cord

25 Core wire

26 Sheath wire

1. A steel cord comprises
a core formed of a single core strand, and
a sheath formed by twisting together six sheath strands arranged around the core; the core strand has a layer-twisted structure comprising
a center-core portion formed by twisting together three core wires, and
an external layer portion formed by twisting together the eight to nine core wires arranged around the center-core portion;
the sheath strand each has either
a bundle-twisted structure formed by bundling and twisting twelve to nineteen sheath wires, or
a multi-layer twisted structure formed by twisting twelve to nineteen sheath wires in layers;
a diameter (dc) of each of the core wires is greater than a diameter (ds) of each of the sheath wires; and
an average gap (Gc) between the core wires of the external layer portion is not less than 0.015 mm, and an average gap (Gs) between the sheath strands is not less than 0.1 mm.

2. The steel cord as set form in claim 1, wherein
a real cord cross-sectional area S1, which is a sum total of a sum of a wire cross-sectional area of the core wire and a sum of a wire cross-sectional area of the sheath wire, is more than 48% and less than 51% of a apparent cord cross-sectional area SO, which is an area of the smallest diameter circumscribed circle among circumscribed circles surrounding the steel cord.

3. The steel cord as set form in claim 1, wherein
a diameter Dc of the core strand is more than 35% of a diameter DO of the steel cord.

4. An elastic crawler including
an endless band-formed crawler main body made of rubber elastic material, and
a tensile member embedded in the crawler main body; wherein
the tensile member comprises a plurality of tensile strength cords continuously extending in a the crawler circumferential direction, and for the tensile strength cord, the steel cord as set forth in claim 1 is employed.
